(19) United States
(12) Patent Application Publication
(10) Pub. No.: US 2008/0122875 A1
(43) Pub. Date: May 29, 2008

(54) Liquid crystal display device and driving circuit and driving method of the same

(75) Inventor: Xiao-Jing Qi, Shenzhen (CN)

Correspondence Address: WEI TE CHUNG;FOXCONN INTERNATIONAL, INC., 1650 MEMOREX DRIVE, SANTA CLARA, CA, 95050, US

(73) Assignees: INNOCOM TECHNOLOGY (SHENZHEN) CO., LTD.; INNOLUX DISPLAY CORP.

(21) Appl. No.: 11/998,021

(22) Filed: Nov. 27, 2007

(30) Foreign Application Priority Data
Nov. 27, 2006 (TW) 95143786

(51) Int. Cl. G09G 5/10

(52) U.S. Cl. 345/690

(57) ABSTRACT

An exemplary liquid crystal display (200) includes a liquid crystal panel (230), a gate driving circuit (210), a data driving circuit (220) and a compensation circuit (290). The liquid crystal panel includes a plurality of gate lines parallel to each other, and a plurality of data lines parallel to each other and intersecting the gate lines. The gate driving circuit is configured for providing a plurality of scanning signals to the gate lines in sequence. The data driving circuit is configured for providing a plurality of gray scale voltages to the data lines. The compensation circuit electrically is connected to the gate lines, configured for compensating the scanning signals. When one gate line is scanned, the compensation circuit applies an external compensation signal to the gate line.

### FIELD OF THE INVENTION

The present invention relates to liquid crystal displays (LCDs) having compensation circuits for reducing gate delays, and further relates to driving circuits and driving method of the same.

### GENERAL BACKGROUND

LCDs are being used in more and more different applications. One trend is that LCDs are becoming bigger in size to suit certain new uses. This means such kind of LCD has a larger viewing area and high definition. LCDs employing thin film transistors (TFTs) are called TFT-LCDs. Generally, TFT-LCDs are prone to have a problem of gate delay due to the elongated gate lines therein, and an associated problem of gate delay phenomenon of scanning signals transmitted therein. Gate delay usually results in image flickering or other display problems.

Referring to FIG. 2, a typical LCD 100 includes a gate driving circuit 110, a data driving circuit 120, and a liquid crystal panel 130. The gate driving circuit 110 is configured for providing a plurality of scanning signals to the liquid crystal panel 130, and the data driving circuit 120 is configured for providing a plurality of gray scale voltages to the liquid crystal panel 130.

The liquid crystal panel 130 includes a plurality gate lines 101 which are parallel to each other, a plurality of data lines 102 which are parallel to each other and which intersect the gate lines 101, a plurality of TFTs 103 arranged at crossings of the gate lines 101 and the data lines 102, a plurality of pixel electrodes 104, and a plurality of common electrodes 105 generally opposite to the pixel electrodes 104. Each of areas bounded by two adjacent gate lines 101 and two adjacent data lines 102 is defined as a pixel area 150. The gate driving circuit 110 sequentially outputs a plurality of scanning signals to the gate lines 101. The data driving circuit 120 applies a plurality of gray scale voltages to source electrodes 1032 (see FIG. 5) of corresponding TFTs 103 when a corresponding gate line 101 is scanned.

Referring also to FIG. 3, an equivalent circuit diagram of one pixel area 150 is shown. A gate electrode 1031 of the TFT 103 is connected to the corresponding gate line 101, the source electrode 1032 of the TFT 103 is connected to the corresponding data line 102, and a drain electrode 1033 of the TFT 103 is connected to the corresponding pixel electrode 104. Because the gate line 101 has a certain inherent resistance R, and a parasitic capacitance Cgd is generated between the gate electrode 1031 and the drain electrode 1033, a resistance-capacitance (RC) delay circuit is formed at the pixel area. In one gate line 101, therefore, many such RC delay circuits are connected in series. The RC delay circuits can delay the scanning signals applied to the gate line 101, and thus the waveform of the scanning signal can be distorted.

Referring also to FIG. 4, this shows scanning signal waveforms provided at two ends of one of the gate lines 101. One end is adjacent to the gate driving circuit 110, and the other end is far from the gate driving circuit 110. “Vg1” is the waveform of the scanning signal at the end of the gate line 101 that is adjacent to the gate driving circuit 110, and “Vg2” is the waveform of the scanning signal at the end of the gate line 101 that is far from the gate driving circuit 110. That is, the waveform “Vg2” is a distorted waveform of the scanning signal, due to delaying by the serial RC delay circuits. “Von” denotes a turn-on voltage of the TFTs 103 along the gate line 101, and “Voff” denotes a turn-off voltage of the TFTs 103 along the gate line 101. Because of the distortion of the waveform of the scanning signal, the turning on of a TFT 103 at the end of the gate line 101 far away from the gate driving circuit 110 is delayed. For example, the delay may be a time period “t” seconds, as shown in FIG. 3. That is, an on-state period of TFTs 103 far from the gate driving circuit 110 is shorter than it should be.

Because a gray scale voltage will not be applied to the drain electrode until the corresponding TFT 103 is turned on, the TFT 103 which is far from the gate driving circuit 110 is not properly charged with the gray scale voltage. Thus, the image display is deteriorated in the corresponding pixel area. Typically, many pixel areas are affected because the corresponding TFTs 103 lack proper charging of gray scale voltages. In this case, the image of the LCD 100 has flickers.

What is needed, therefore, is a liquid crystal display which can overcome the above-described deficiencies.

### SUMMARY

An exemplary liquid crystal display includes a liquid crystal panel, a gate driving circuit, a data driving circuit and a compensation circuit. The liquid crystal panel includes a plurality of gate lines parallel to each other, and a plurality of data lines parallel to each other and intersecting the gate lines. The gate driving circuit is configured for providing a plurality of scanning signals to the gate lines in sequence. The data driving circuit is configured for providing a plurality of gray scale voltages to the data lines. The compensation circuit electrically is connected to the gate lines, configured for compensating the scanning signals. When one gate line is scanned, the compensation circuit applies an external compensation signal to the gate line.

Other novel features and advantages of the liquid crystal display will become more apparent from the following detailed description when taken in conjunction with the accompanying drawings.

### BRIEF DESCRIPTION OF THE DRAWINGS

FIG. 1 is essentially an abbreviated circuit diagram of a liquid crystal display according to a first embodiment of the present invention.

FIG. 2 is essentially an abbreviated circuit diagram of a conventional liquid crystal display, the liquid crystal display including a liquid crystal panel, the liquid crystal panel including a plurality of pixel areas.

FIG. 3 is an equivalent circuit diagram of one of the pixel areas of FIG. 2.

FIG. 4 is a voltage-time graph relating to the liquid crystal display of FIG. 3, illustrating a gate delay phenomenon.

### DETAILED DESCRIPTION OF PREFERRED EMBODIMENTS

Reference will now be made to the drawings to describe preferred and exemplary embodiments of the present invention in detail.

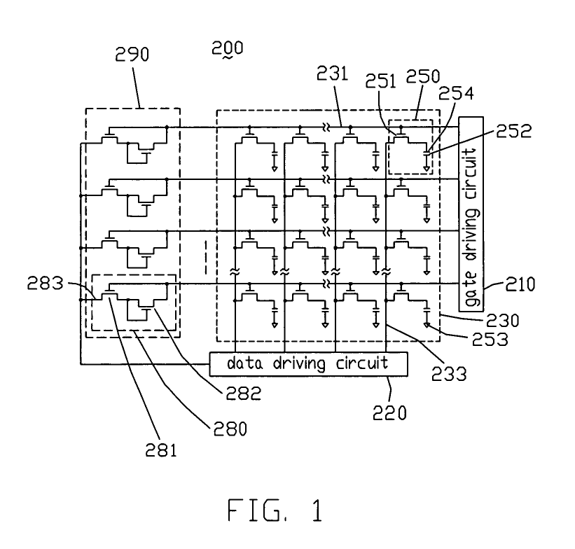

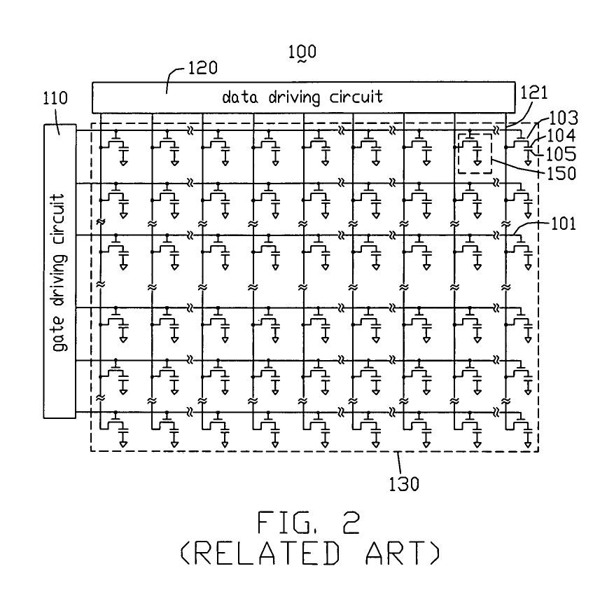

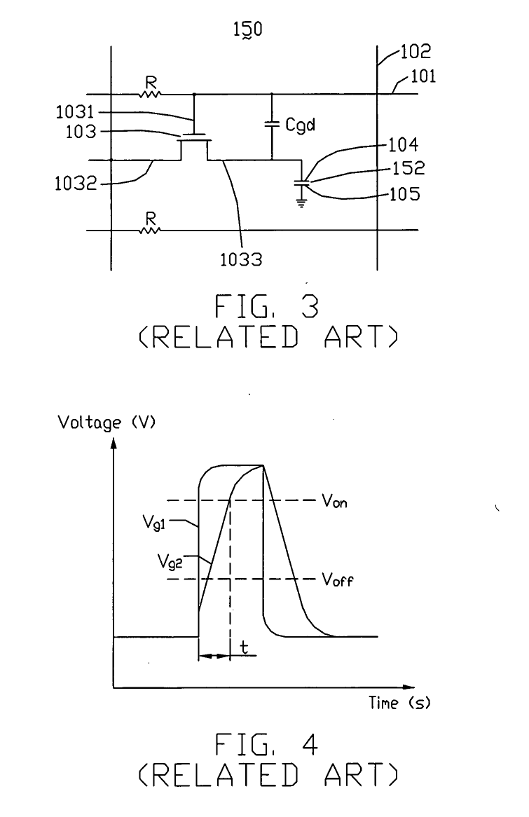

Referring to FIG. 1, a circuit diagram of a liquid crystal display device 200 according to a first embodiment of the present invention is shown. The liquid crystal display 200 includes a gate driving circuit 210, a data driving circuit 220, a liquid crystal panel 230, and a compensation circuit 290. The gate driving circuit 210 is configured for providing a plurality of scanning signals to the liquid crystal panel 230, and the data driving circuit 220 is configured for providing a plurality of gray scale voltages to the liquid crystal panel 230. The compensation circuit 290 is configured for providing a plurality of compensation signals to the liquid crystal panel 230.

The liquid crystal panel 230 includes a plurality gate lines 231 (G1˜G2n, where n is a natural number) which are parallel to each other, a plurality of data lines 233 which are parallel to each other and which intersect the gate lines 231, a plurality of TFTs 251 arranged at crossings of the gate lines 231 and the data lines 233, a plurality of pixel electrodes 254, and a plurality of common electrodes 253 generally opposite to the pixel electrodes 254. Each of areas bounded by two adjacent gate lines 231 and two adjacent data lines 233 is defined as a pixel area 250. One end of each gate line 231 is connected to the gate driving circuit 210, and an opposite end, i.e. a tail end, of each gate line 231 is connected to the compensation circuit 290. The data lines 233 are connected to the data driving circuit 220.

The TFTs 251 each include a gate electrode (not labeled) connected to the corresponding gate line 231, a source electrode (not labeled) connected to the corresponding data line 233, and a drain electrode (not labeled) connected to the corresponding pixel electrode 254. The gate driving circuit 210 sequentially outputs a plurality of scanning signals to the gate lines 231. The data driving circuit 220 applies a plurality of gray scale voltages to source electrodes of the corresponding TFTs 251 when each gate line 231 is scanned.

The compensation circuit 290 includes a plurality of compensation units 280, and a voltage input terminal 283. The compensation units 280 each include a first TFT 281, a second TFT 282. For each compensation unit, the input terminal 283 is a source electrode of the first TFT 281, which is connected to a 15V direct current voltage signal line of the data driving circuit 220. A gate electrode of the first TFT 281 and a drain electrode of the second TFT 282 are connected to the tail end of the gate line 231. A drain electrode of the first TFT 281 and a source electrode and a gate electrode of the second TFT 282 are short-circuit.

When a scanning signal is applied to one gate line 231 from the gate driving circuit 210, the TFTs 251 connected to the gate line 231 adjacent to the gate driving circuit 210 are turned on, and the data signals are provided to a corresponding storage capacitor 252 through the corresponding data lines 233 and the turn-on TFT 251. Because the gate line 231 has a certain inherent resistance R, and a parasitic capacitance Cgd is generated between the gate electrode and the drain electrode, a resistance-capacitance (RC) delay circuit is formed at the pixel area. Thus, the scanning signal provided at the tail end of the corresponding gate line 231 is delayed.

After a delayed time, the scanning signal provided to the tail end of the corresponding gate line 231 turns on the first TFT 281 of the corresponding compensation unit 280. Thus, the 15V direct current voltage turns on the second TFT 282 through the input terminal 283, the source electrode and the drain electrode of the first TFT 281, and then is provided to the tail end of the corresponding gate line 231 through the source electrode and the drain electrode of the second TFT 282, to compensate the delay of the corresponding TFT 251 connected to the tail end of the gate line 231. Thus, the data driving circuit 220 has enough time to write the gray scale voltage to the corresponding capacitor 252.

The gate driving circuit 210 scans the plurality of gate lines 231 one by one, and the scanning signals provided to the tail ends of the corresponding gate lines 231 also turn on the plurality of compensation units 280 one by one, and then the compensation units 280 transmit the 15V direct current voltage to the corresponding tail ends of the corresponding gate lines 231. In one pixel frame, after the gate driving circuit 210 scans each gate line 231, no scanning signal is provided to the gate line 231 again. Thus, the corresponding compensation unit 280 connected to the gate line 231 is turned off and the 15V direct current voltage should not be provided to the tail end of the gate line 231.

With this configuration, the LCD panel 230 utilizes the compensation circuit 290 to provide a high-level voltage to the tail end of the gate line 231 when the gate line is scanned. Thus, the compensation circuit 290 can compensate the on-state period of the corresponding TFT 251 to assure the data driving circuit 220 having enough time to write the gray scale voltage to the storage capacitor 252. Therefore, the data voltage signals influenced by the electrical leakages of the storage capacitors in conventional technology are compensated, which helps ensure that the LCD panel 230 can provide a high display performance.

Other alternative embodiments can include the following. The input terminal 283 of the compensation unit 280 is not limited to connect with the 15V direct current voltage signal line of the data driving circuit 220, which can connect to other external circuits or other 15V direct current voltage signal sources. In addition, the compensation voltage is not limited to 15V direct current voltage for applying to different LCD panels 230.

It is to be further understood that even though numerous characteristics and advantages of preferred and exemplary embodiments have been set out in the foregoing description, together with details of the structures and functions of the embodiments, the disclosure is illustrative only; and that changes may be made in detail, especially in matters of shape, size, and arrangement of parts within the principles of the present invention to the full extent indicated by the broad general meaning of the terms in which the appended claims are expressed.

What is claimed is:

1. A liquid crystal display device comprising:
a liquid crystal panel comprising a plurality of gate lines parallel to each other, and a plurality of data lines parallel to each other and intersecting the gate lines;
a gate driving circuit configured for providing a plurality of scanning signals to the gate lines in sequence;
a data driving circuit configured for providing a plurality of gray scale voltages to the data lines; and
a compensation circuit electrically connected to the gate lines, configured for compensating the scanning signals, wherein, when one gate line is scanned, the compensation circuit applies an external compensation signal to the gate line.

2. The liquid crystal display device in claim 1, wherein one end of each of the gate lines is connected to the gate driving circuit, and an opposite end of each of the gate lines is connected to the compensation circuit.

3. The liquid crystal display device in claim 1, wherein the compensation circuit comprises a plurality of compensation units, each compensation unit being connected to one gate line, the gate lines being scanned successively, the compensation unit providing the compensation signal to the corresponding gate line when the corresponding gate line is scanned.

4. The liquid crystal display device in claim 3, wherein the compensation unit comprises a plurality of compensation units, and a voltage input terminal, the compensation units each including a first TFT, a second TFT, the input terminal being a source electrode of the first TFT, a gate electrode of the first TFT and a drain electrode of the second TFT being connected to the tail end of the gate line, a drain electrode of the first TFT and a source electrode and a gate electrode of the second TFT being short-circuit.

5. The liquid crystal display device in claim 4, wherein the input terminal is connected to the direct current voltage signal line of the data driving circuit.

6. The liquid crystal display device in claim 1, wherein the scanning signals from the gate driving circuit is equal to the external compensation signal provided by the compensation circuit.

7. The liquid crystal display device in claim 1, wherein the external compensation signal is 15V direct current voltage.

8. A driving circuit for a liquid crystal display device comprising:
a liquid crystal panel comprising a plurality of gate lines parallel to each other, and a plurality of data lines parallel to each other and intersecting the gate lines;
a gate driving circuit configured for providing a plurality of scanning signals to the gate lines in sequence;
a data driving circuit configured for providing a plurality of gray scale voltages to the data lines; and
a compensation circuit electrically connected to the gate lines, configured for compensating the scanning signals, wherein when one gate line is scanned, the compensation circuit applies an external compensation signal to the gate line.

9. The driving circuit in claim 8, wherein one end of each of the gate lines is connected to the gate driving circuit, and an opposite end of each of the gate lines is connected to the compensation circuit.

10. The driving circuit in claim 8, wherein the compensation circuit comprises a plurality of compensation units, each compensation unit being connected to one gate line, the gate lines being scanned successively, the compensation unit providing the compensation signal to the corresponding gate line when the corresponding gate line is scanned.

11. The driving circuit in claim 10, wherein the compensation unit comprises a plurality of compensation units, and a voltage input terminal, the compensation units each comprising a first TFT, a second TFT, the input terminal being a source electrode of the first TFT, a gate electrode of the first TFT and a drain electrode of the second TFT being connected to an end of the gate line, a drain electrode of the first TFT and a source electrode and a gate electrode of the second TFT being short-circuit.

12. The driving circuit in claim 11, wherein the input terminal is connected to the direct current voltage signal line of the data driving circuit.

13. The driving circuit in claim 8, wherein the scanning signals from the gate driving circuit is equal to the external compensation signal provided by the compensation circuit.

14. The driving circuit in claim 8, wherein the external compensation signal is 15V direct-current voltage.

15. A driving method for a liquid crystal display comprising following processes:
providing a gate driving circuit for providing a plurality of scanning signals to a plurality of gate lines of the LCD in sequence;
providing a compensation circuit for providing an external compensation signal to one end of the gate line far away the gate driving circuit, which compensating the plurality of scanning signals one by one.

16. The method in claim 15, wherein the compensation circuit comprises a plurality of compensation units, each compensation unit being connected to one gate line, the gate lines being scanned successively, the compensation unit providing the compensation signal to the corresponding gate line when the corresponding gate line is scanned.

17. The method in claim 15, wherein the scanning signals from the gate driving circuit is equal to the external compensation signal provided by the compensation circuit.

18. The method in claim 15, wherein the external compensation signal is from the direct current voltage signal line of a data driving circuit of the LCD.

19. The method in claim 15, wherein in one pixel frame, after the gate driving circuit scans each gate line, no scanning signal is provided to the gate line again.
